(19) United States
(12) Patent Application Publication
(10) Pub. No.: US 2025/0244933 A1
(43) Pub. Date: Jul. 31, 2025

(54) METHODS AND SYSTEMS FOR PRINTING A DOCUMENT USING A MACHINE-READABLE CODE

(71) Applicant: XEROX CORPORATION, Norwalk, CT (US)

(72) Inventors: Ashok Jason Vedaraj, Chennai (IN); Srinivasarao Bindana, Kakinada (IN); Shoban Kumar Jayaraj Devadoss, Chennai (IN); Jagadeeswaran Lakshmipathy, Chennai (IN); Prasanth Kalaiselvan, THARANGAMBADI (T.K) (IN)

(73) Assignee: XEROX CORPORATION, Norwalk, CT (US)

(21) Appl. No.: 18/427,934

(22) Filed: Jan. 31, 2024

(51) Int. Cl. G06F 3/12

(52) U.S. Cl. CPC G06F 3/1271; G06F 3/1204; G06F 3/128

(57) ABSTRACT

The present disclosure discloses methods and systems for generating a machine-readable code for printing a document for a requesting user is disclosed. The method is implemented on a computing device used by the requesting user. The method includes receiving a request from the requesting user for generating the machine-readable code for printing the document for the requesting user. Thereafter, details related to printing the document are obtained, wherein the details include printer details of a preferred printer of the requesting user, requesting user details, and execution details. Once obtained, the machine-readable code including the details related to printing the document is generated. Thereafter, the requesting user is allowed to share the machine-readable code with a remote user such that the remote user submits the document for printing for the requesting user at the preferred printer without sharing the document with the requesting user.

### TECHNICAL FIELD

The present disclosure relates to document printing, more specifically, relates to methods and systems for printing a document using a machine-readable code.

### BACKGROUND

There are numerous occasions where users are required to share or submit a physical version of a document with one or more other users. For example, a user may be required to share a physical version of purchase orders with a finance team. In another example, a user may be required to submit a physical version of an identity document while joining the organization. In such cases, the user can share the document either by sharing a digital version of the document or a physical version of the document. In the former scenario, the user first shares the digital version of the document with the other user, say the finance team, who then takes a print of the document for further use. However, sharing the digital version of the document may pose a security threat as there are chances of mishandling of the digital version of the document by the other user. In the latter scenario, the user takes the printout himself and shares the physical version of the document with the other user via a courier service or by personally visiting the other user. This can be time-consuming and inconvenient for the user. In this light, there is a need for methods and systems that offer convenience to the user and ensure the security of the document shared.

### SUMMARY

According to aspects illustrated herein, a method for generating a machine-readable code for printing a document for a requesting user is disclosed. The method is implemented on a computing device used by the requesting user. The method includes receiving a request from the requesting user for generating the machine-readable code for printing the document for the requesting user. Thereafter, details related to printing the document are obtained, wherein the details include printer details of a preferred printer of the requesting user, requesting user details, and execution details. Once obtained, the machine-readable code including the details related to printing the document is generated. Thereafter, the requesting user is allowed to share the machine-readable code with a remote user such that the remote user submits the document for printing for the requesting user at the preferred printer without sharing the document with the requesting user.

According to further aspects illustrated herein, a method for submitting a print job for a requesting user using a machine-readable code is disclosed. The method is implemented at a print application running on a computing device of a remote user. The method includes receiving a request to upload a machine-readable code, wherein the machine-readable code includes at least one of: printer details of a preferred printer of the requesting user, requesting user details, and execution details. Thereafter, the printer details, requesting user details, and execution details are retrieved from the machine-readable code, and the print job is automatically configured based on the printer details and the execution details retrieved from the machine-readable code. Once configured, the remote user is allowed to submit the print job including a document such that the document is directly printed at the preferred printer of the requesting user without requiring the remote user to share the document with the requesting user.

According to yet another aspect illustrated herein, a computing device for generating a machine-readable code for printing a document for a requesting user is disclosed. The computing device is for: receiving a request from the requesting user for generating the machine-readable code for printing the document for the requesting user; obtaining details related to printing the document, wherein the details include printer details of a preferred printer of the requesting user, requesting user details, and execution details; generating the machine-readable code including the details related to printing the document; and allowing the requesting user to share the machine-readable code with a remote user such that the remote user submits the document for printing for the requesting user at the preferred printer without sharing the document with the requesting user.

According to yet another aspect illustrated herein, a computing device for submitting a print job for a requesting user is disclosed. The computing device is for: receiving a request to upload a machine-readable code, wherein the machine-readable code includes at least one of: printer details of a preferred printer of the requesting user, requesting user details, and execution details; retrieving the printer details, requesting user details, and execution details, from the machine-readable code; automatically configuring the print job based on the printer details and the execution details retrieved from the machine-readable code; and allowing the remote user to submit the print job including a document such that the document is directly printed at the preferred printer of the requesting user without requiring the remote user to share the document with the requesting user.

According to yet another aspect illustrated herein, a method for printing a document for a requesting user using a machine-readable code is disclosed, wherein the document belongs to a remote user. The method includes receiving a request from the requesting user for generating the machine-readable code for printing the document for the requesting user; generating the machine-readable code including details for printing the document, wherein the details include at least: printer details of a preferred printer of the requesting user, requesting user details, and execution details; allowing the requesting user to share the machine-readable code with the remote user for printing the document; receiving a request to upload the machine-readable code from the remote user, wherein the machine-readable code includes at least: the printer details of the preferred printer of the requesting user, requesting user details, and execution details; retrieving the printer details, requesting user details, and execution details, from the machine-readable code; automatically configuring the document for printing, based on the printer details and the execution details retrieved from the machine-readable code; and allowing the remote user to submit the document for printing such that the document is directly printed at the preferred printer of the requesting user without requiring the remote user to share the document with the requesting user.

According to additional aspects illustrated herein, a system for printing a document for a requesting user using a machine-readable code is disclosed, wherein the document belongs to a remote user. The system includes a requesting user's device for: receiving a request from the requesting user for generating the machine-readable code for printing the document for the requesting user; generating the machine-readable code including details for printing the document, wherein the details include at least: printer details of a preferred printer of the requesting user, requesting user details, and execution details; allowing the requesting user to share the machine-readable code with the remote user for printing the document. Further, the system includes a remote computing device for: receiving a request to upload the machine-readable code from the remote user, wherein the machine-readable code includes at least: the printer details of the preferred printer of the requesting user, requesting user details, and execution details; retrieving the printer details, requesting user details, and execution details, from the machine-readable code; automatically configuring the document for printing, based on the printer details and the execution details retrieved from the machine-readable code; and allowing the remote user to submit the document for printing such that the document is directly printed at the preferred printer of the requesting user without requiring the remote user to share the document with the requesting user.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 shows an exemplary environment in which various embodiments of the present disclosure can be practiced.

FIG. 2 is a block diagram illustrating various components of a first computing device, a printer, and a second computing device, in accordance with an embodiment of the present disclosure.

FIG. 3 is an exemplary snapshot of a user interface of a print application, in accordance with an embodiment of the present disclosure.

FIG. 4 is a method flowchart for generating a machine-readable code for printing a document for a requesting user, in accordance with an embodiment of the present disclosure.

FIG. 5 is a method flowchart for submitting a print job for a requesting user using a machine-readable code, in accordance with an embodiment of the present disclosure.

FIG. 6 is a complete method flowchart for printing a document using a machine-readable code.

### DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

### Non-Limiting Definitions

In various embodiments of the present disclosure, definitions of one or more terms that will be used in the document are provided below. For a person skilled in the art, it is understood that the definitions are provided just for the sake of clarity and are intended to include more examples in addition to the examples provided below.

The term “printer” refers to a single device that perform one or more functions such as, but not limited to, printing, imaging, scanning, copying, or the like. The printer may include software, hardware, firmware, or a combination thereof. In the context of the current disclosure, the printer generates a machine-readable code for printing a document for a requesting user. The printer is further deployed/present/installed at the requesting user's end.

The term “print application” refers to an application installed on a device such as a laptop, desktop, printer, etc., to facilitate the printing of the document. The print application may be installed on a computing device of the requesting user and/or may be installed on a computing device of the remote user. In the context of the disclosure, the print application installed on the computing device of the requesting user generates a machine-readable code, say a QR code, the generated QR code is further shared with the remote user. The print application installed on the computing device of the remote user allows the remote user to upload the QR code and configure the print job according to the details included in the QR code.

The term “computing device” refers to a device that the user typically uses for his day-to-day work, submitting print jobs and other purposes. Examples of the computing device include, but are not limited to, a personal computer, a desktop, a laptop, a mobile phone, a mobile device, a tablet, a Personal Digital Assistant (PDA), a smart-phone or any other device capable of submitting a document for printing. In the context of the current disclosure, the computing device may include a pre-defined application such as a print application.

The term “document” refers to a document that belongs to a remote user and the document needs to be shared with a requesting user without sharing the actual document, for example, the digital version of the document. The document may be referred to as a source document.

The term “requesting user” refers to a user who wishes to have a printed document from another user, for example, a remote user. The remote user refers to a user who is located remotely from the requesting user. For example, the requesting user may be located in city A and the remote user may be located in city B.

The term “requesting user details” refers to details or information related to the requesting user. Exemplary details include user name, user ID, user's employee ID, and the like. In the context of the disclosure, the requesting user details are used for generating the machine-readable code.

The term “preferred printer” refers to a printer where the document is printed for the requesting user. The preferred printer is accessible by the requesting user. For example, the preferred printer may be present at the home location of the requesting user. Or maybe present in his office location.

The term “printer details” refers to one or more details related to a printer that can help to identify the printer on a network. The printer details include, but not limited to, IP address, MAC address, hostname, domain name, or any other identifier associated with the printer to identify the printer on a network. In the context of the disclosure, printer details of a preferred printer of the requesting user are used for generating the machine-readable code.

The term “execution details” refers to include one or more parameters according to which the document is printed. The execution details may be different from the requesting user details and the printer details as discussed above. Some examples of the parameters include print type such as black & white, or colored print; page orientation such as landscape or portrait mode; pages to be printed, single-sided or both-sided print, printer tray, page size, and the like.

The term “machine-readable code” refers to a code that includes machine-readable information. In the context of the disclosure, the machine-readable code includes information for printing the document for the requesting user. Exemplary information includes printer details, requesting user details, and execution details. In one example, the machine-readable code can be a two-dimensional code such as a QR code. In another example, the machine-readable code can be a one-dimensional code such as a barcode. The machine-readable code can be any known or later developed code, without limiting the scope of the disclosure.

The term “configuring a print job” refers to inputting various details such as printer details, execution details, etc., for printing the document for the requesting user. For example, the printer details and the execution details are retrieved from the machine-readable code and the print job is automatically configured based on the retrieved details when the remote user submits the document for printing from his computing device. The execution details may include but not limited to, number of copies to be printed, print type, page orientation, or the like.

The term “print job” refers to a job including a document to be printed on the printer.

The term “without sharing the document” refers to include without sharing the digital version of the document or the original document of the remote user so that no modifications/edits/manipulation can be done with the document.

The first computing device is used in the context of the requesting user, the second computing device is used in the context of the remote user, and the printer or preferred printer is used in the context of the requesting user.

### Overview

The present disclosure discloses methods and systems for printing a document using a machine-readable code such as a QR code. Specifically, the methods and systems allow a remote user to use a machine-readable code, for printing a document for a requesting user without sharing the document with the requesting user via email, or other ways of sharing the document. According to the disclosure, a requesting user uses a print application running on his computing device to generate a machine-readable code, say a QR code, including printer details of a preferred printer, requesting user details, and execution details. The generated QR code is shared with a remote user for printing the document. Once received, the remote user submits the document for printing. Specifically, the remote user uses his computing for submitting the document for printing. The remote user uploads the QR code using a print application running on his computing device. Once uploaded, the details embedded in the QR code are automatically retrieved to configure the print job or to submit the document for printing. The document is finally submitted for printing such that the document is directly printed at the preferred printer of the requesting user. The requesting user can finally collect the printed document from the preferred printer. Therefore, the remote user can place the print job by simply selecting the document to be printed and uploading the received QR code using a print application installed on his computing device. This way, the methods and systems allow the remote user to print the desired document for the requesting user without sharing the document with him, thereby keeping the original document safe.

### Exemplary Environment

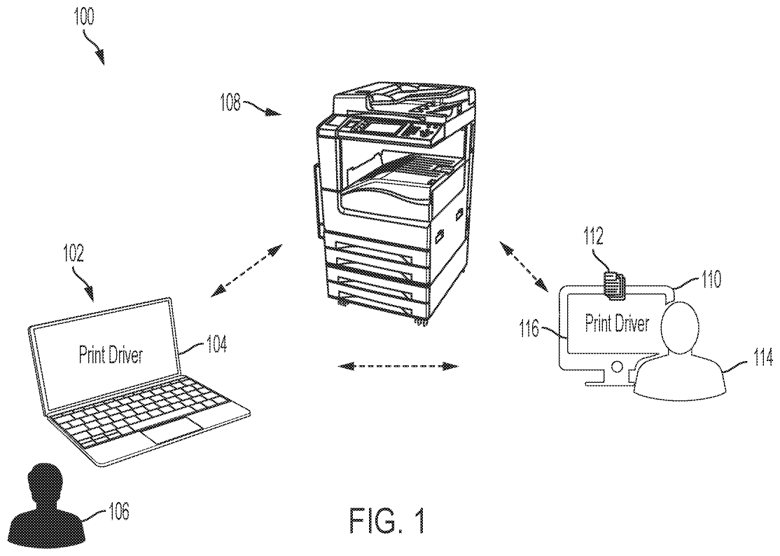

FIG. 1 shows an exemplary environment 100 in which various embodiments of the disclosure can be practiced. The environment 100 is shown to include a first computing device 102, a printer 108, and a second computing device 110. The first computing device 102 may be any device that a user uses for his day-to-day work such as emails, chat, surfing, work, or the like. Further, the first computing device 102 is communicatively coupled to the printer 108 via Wi-Fi, Bluetooth, for example. Wi-Fi and Bluetooth technology are just two examples, the first computing device 102 can be paired with the printer 108 using any known or later developed technologies. The printer 108 may be any device that provides one or more functionalities such as printing, scanning, imaging, copying, and so on. Various examples of the printer 108 may be a multi-function printer, or the like. Furthermore, the second computing device 110 is communicatively coupled to the first computing device 102 and the printer 108 via the internet, intranet, Wide Area Network (WAN), telephone network, echonet (ECHONET), and the like. The first computing device 102 may be used by a requesting user 106, whereas the second computing device 110 may be used by the remote user 114. Further, the printer 108 is a preferred printer for the requesting user 106.

The implementation begins when a requesting user 106 wishes to receive a document 112 from the remote user 114, where the document 112 belongs to the remote user 114 and the remote user 114 does not wish to share the digital version of the document 112. For example, the remote user 114 does not wish or cannot share the digital version of the document 112 with the requesting user 106 because the document 112 is confidential. The remote user 114 wants/requires to share the document 112 with the requesting user 106 but without sharing the original or digital version of document 112 with the requesting user 106. For example, by directly printing the document 112 at a printer 108, which is the preferred printer of the requesting user 106. Therefore, the requesting user 106 accesses a print application, i.e., the print application 104 installed on the first computing device 102. The print application 104 is just an example, print application can be a phone printing application, web application, etc., which can be used for submitting a print job for printing the document. Once accessed, the print application 104 displays various options to allow the requesting user 106 to configure the print job. In the context of the disclosure, the print application 104 also displays a new option that allows the requesting user 106 to generate a machine-readable code such as a QR code which the requesting user 106 can use to receive a desired document such as the document 112 from another user via his/her preferred printer, such as the printer 108. Once displayed, the requesting user 106 selects the new option. To this end, the requesting user 106 is first required to select a preferred printer, say the printer 108, and configure the print parameters by inputting execution details. Thereafter, the print application 104 obtains the printer details, requesting user details and execution details. Once obtained, the print application 104 generates a QR code such that the generated QR code includes the printer details, requesting user details and execution details required for printing the document 112. Thereafter, the requesting user 106 shares the QR code with the remote user 114. The QR code can be shared with the remote user 114 via email, message, text message, other known or later-developed ways of sharing the QR code. The remote user 114 receives the QR code.

Once received, the remote user 114 selects the desired document, i.e., the document 112, and submits the document 112 for printing using a print application 116. While submitting, the print application 116 displays various options to allow the remote user 114 to configure the print job/document for printing. Further, the print application 116 displays a new option that allows the remote user 114 to upload the received QR code. Using the new option, the remote user 114 uploads the received QR code. Once uploaded, the print application 116 processes the QR code, specifically the information embedded in the QR code, and automatically configures the print job according to the information embedded in the QR code. For example, the details are automatically populated at the time of submitting the document 112 for printing such as a printer for printing, number of copies, print type etc. Here, the remote user 114 is not required to input any information for printing the document 112. In this case, the automatically populated printer is the printer 108 which is the preferred printer of the requesting user 106. Once configured, the remote user 114 submits the document 112 for printing directly at the printer 108. The document 112 is submitted for printing such that the document 112 gets printed directly at the printer 108. Thereafter, the requesting user 106 can access the printer 108 and collect the printed document. In some cases, the requesting user 106 can release the document for printing at the printer 108 by inputting a secure code, etc.

### Exemplary System

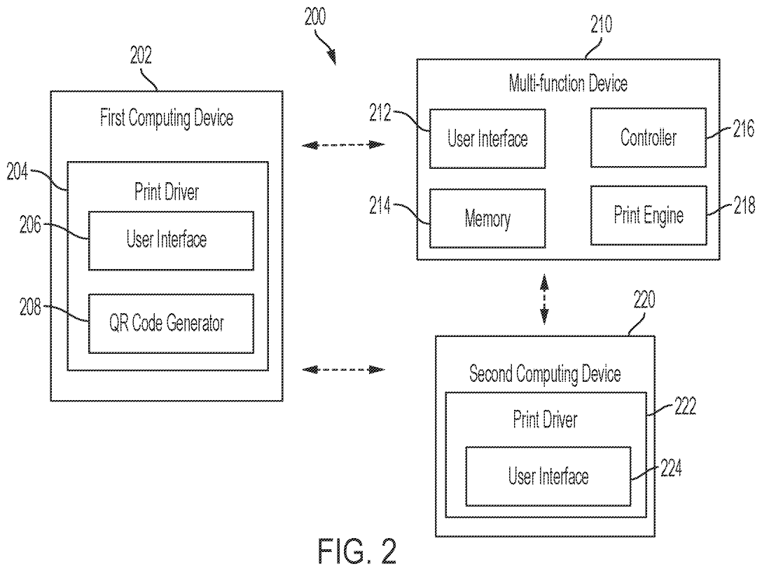

FIG. 2 is a block diagram illustrating various components of a system 200 including a first computing device 202, a printer 210 and a second computing device 220 for implementing the current disclosure. As shown, the first computing device 202 includes a print application 204 which further includes a user interface 206 and a machine-readable code generator, such as a QR code generator 208. And, the second computing device 220 includes a print application 222 including a user interface 224. Further, the printer 210 includes a user interface 212, a memory 214, a controller 216, and a print engine 218. Although the user interface 206 is a part of the printer 210, but the user interface 206 can be an external display or device that can be connected to the printer 210. Here, the first computing device 202, the second computing device 220, and the printer 210 may further include additional component(s) as required to implement the present disclosure. Further, the first computing device 202 may be used by a requesting user, whereas the second computing device 220 may be used by the remote user.

In the context of the disclosure, the printer 210 and the first computing device 202 are located within a small distance, e.g., within the same floor, same building, same premises, etc. And, the requesting user can easily access the printer 210 and use the first computing device 202 to perform various tasks such as printing. In another example, the printer 210 is a preferred printer for the requesting user. Here, the printer 210 and the first computing device 202 may be communicatively coupled via intranet, Local Area Network (LAN), Wi-Fi, Bluetooth, and the like. Further, the second computing device 220 may be located at a remote location from the first computing device 202 and the printer 210. And, the second computing device 220 may be communicatively coupled via internet, intranet, Wide Area Network (WAN), telephone network, VPN, echonet (ECHONET), and the like. In one example, the first computing device 202, the printer 210 and the second computing device 220 are connected to each other through a common network of an organization. Although, the disclosure is explained with respect to a scenario where the first computing device 202 and the printer 210 are located within a small distance from each other, and the second computing device 220 is located at a remote location. However, the disclosure can also be implemented in a scenario in which the second computing device 220 is also located within a small distance, say within the same floor, building, etc., from the first computing device 202 and the printer 210.

The implementation begins when a user, say the requesting user wishes to receive a document from another user, say the remote user, where the document belongs to the remote user and the remote user does not wish to share the digital version of the document. Here, the remote user wants/requires to share the document with the requesting user but without sharing the original or digital version of the document with the requesting user. Therefore, to receive the document the requesting user accesses the print application, i.e., the print application 204 installed on his computing device, i.e., the first computing device 202. The print application 204 can be a phone printing application, web application, etc., which can be used for submitting a print job for printing the document. Once accessed, the user interface 206 presents multiple options to allow the requesting user to configure a print job. Exemplary options include a printer selection option which allows the requesting user to select a preferred printer from a list of printers, options for providing execution details such as single-sided or both-sided print; black and white or colored print; number of copies, orientation, etc. In the context of the current disclosure, the user interface 206 displays a new option, say “generate QR code to receive document” option. The new option allows the requesting user to generate a QR code to receive the document from the remote user via a preferred printer, such as the printer 210. Once displayed, the requesting user can select the new option. Here, before selecting the new option, the requesting user is required to configure the print job. For example, the requesting user selects a desired printer, say the printer 210, and inputs execution details such as black & white, or colored print; page orientation such as landscape or portrait mode; pages to be printed, single-sided or both-sided print, printer tray, page size, and the like. Once configured, the requesting user selects the new option.

Thereafter, the print application 204 obtains printer details, requesting user details, and execution details. For example, the print application 204 directly obtains the requesting user details such as username, user ID, employee ID, email address, etc., from the computing device or log in details of the requesting user. Further, the print application 204 can obtain the printer details from the requesting user, for example, the requesting user can input the name of the preferred printer or select the preferred printer. Then, the print application 204 automatically obtains the printer details such as IP address, MAC address, Hostname, Domain name, or any other suitable identifier associated with the printer. Similarly, based on the input provided by the requesting user while configuring the print job, the print application 204 obtains the execution details such as the number of copies, number of pages to be printed, type of printing, print orientation, etc. Once obtained, the print application 204 forwards the obtained information to the QR code generator 208.

Once received, the QR code generator 208 generates a QR code using the received information which includes printer details of the preferred printer of the requesting user, requesting user details, and execution details. In one example, the QR code generator 208 processes the received information and generates a unique two-dimensional arrangement of squares to generate the QR code. Thereafter, the QR code generator 208 presents the generated QR code on the user interface 206. Thereafter, the requesting user shares the displayed QR code with the remote user via email, text message, chatting applications, or the like.

Once received, the remote user downloads and saves the received QR code on his computing device, say the second computing device 220. Thereafter, the remote user accesses the document requested by the requesting user on his computing device, i.e., the second computing device 220, and initiates print, e.g., by selecting the print option. Once initiated, the print application 222 of the second computing device 220 presents various options via the user interface 224 to allow the remote user to configure the print job. Exemplary options include printer selection option, print type such as black & white, or colored print; page orientation such as landscape or portrait mode; pages to be printed, single-sided or both-sided print, printer tray, page size, and the like.

In the context of the current disclosure, the user interface 224 also presents a new option, say “upload QR code”. The new option allows the remote user to upload the QR code received from the requesting user and submit the document for printing at the preferred printer 210 selected by the requesting user. And, this allows the remote user to print the document for the requesting user without sharing the digital version of the document. In one example, the new option is displayed to the remote user in a drop-down list, that is displayed when the remote user selects the printer option to select the printer. Once displayed, the remote user selects the new option and uploads the QR code obtained from the requesting user, which may be saved in the memory (not shown) of the second computing device 220.

Once uploaded, the print application 222 processes the QR code and retrieves/extracts the embedded information which includes printer details, requesting user details, and execution details. Thereafter, the print application 222 automatically configures a print job for printing the document according to the retrieved information. In detail, the print application 222 uses the printer details which includes information such as IP address, MAC address, hostname, domain name, etc., associated with the printer 210 to identify the printer 210 on the network and selects the printer 210 for printing, i.e., the preferred printer of the requesting user to print the document. Further, the print application 222 configures the other parameters related to the print job, such as, print type, orientation, margins, page size, and the like, based on the execution details retrieved from the QR code. Once configured, the updated print job including printer 210 as the selected printer (preferred printer of the requesting user) and other updated parameters are displayed to the remote user via the user interface 224. Thereafter, the remote user submits the print job, e.g., by selecting the print option. Once selected, the print application 222 sends the selected document for printing to the selected printer, i.e., the printer 210. Further, the print application 222 sends the requesting user details extracted from the QR code to the printer 210.

Once received, the printer 210 stores the print job in a queue associated with a user profile of the requesting user. The queues associated with one or more user profiles are stored in the memory 214 of the printer 210. Specifically, the controller 216 receives the document and the requesting user details. And, using the requesting user details, the controller 216 stores the document in a queue associated with the user profile, i.e., the document or print job is listed in the user profile of the requesting user. In one example, once the job is received at the printer 210 or once the job is saved in a queue associated with the user profile, the requesting user is notified. The requesting user may be notified via an email or a text message. In another example, once the job is submitted by the remote user, the print application 222 of the second computing device 220 notifies the requesting user using the requesting user details, which may include the contact details of the requesting user.

Thereafter, the requesting user accesses the printer 210, specifically, the user interface 212 of the printer 210. In one example, the requesting user first authenticates himself using valid credentials and once authenticated, the requesting user can access his/her profile. Once accessed, the user interface 212 displays various options such as print, scan, jobs, or the like. The user interface 212 also displays the list of jobs which includes the document or the print job submitted by the remote user. Thereafter, the requesting user selects and submits the document for printing. Once selected, the controller 216 triggers the print engine 218 to print the document, and the print engine 218 prints the document according to the print parameters and outputs the document. Thereafter, the requesting user can use the document.

Although, the disclosure is explained with respect to a QR code, however, the disclosure can be implemented using any known or later developed machine-readable codes.

The present disclosure discloses a system 200 for printing a document for a requesting user using a machine-readable code, where the document belongs to a remote user. The system 200 includes a requesting user's computing device, i.e., the first computing device 202, a remote user's computing, i.e., the second computing device 220 and a printer 210. The requesting user uses the first computing device 202 for generating a machine-readable code. Specifically, the requesting user uses a print application 204 running on his computing device, i.e., the first computing device 202 for generating the machine-readable code. The print application 204 receives a request from the requesting user for generating the machine-readable code for printing the document for the requesting user. The print application 204 further obtains relevant information required for printing the document such as, printer details of a preferred printer of the requesting user, requesting user details, and execution details. The print application 204 finally generates the machine-readable code including details for printing the document. The print application 204 embeds the printer details of the preferred printer of the requesting user, requesting user details, and execution details in the machine-readable code. Finally, the print application 204 allows the requesting user to share the machine-readable code with the remote user for printing the document using one or more ways. The remote user receives the machine-readable code and submits his document for printing for the requesting user. The remote user uses the second computing device 220 for submitting the document for printing using the machine-readable code. The remote user may use his computing device, i.e., the second computing device 220 to receive the machine-readable code generated by the remote user. Further, the remote user uses a print application 222 running on the second computing device 220 to upload the received machine-readable code, wherein the machine-readable code includes at least: the requesting user details, the printer details of the preferred printer of the requesting user, and the execution details. Once uploaded, the print application 222 retrieves the requesting user details, the printer details, and the execution details, from the machine-readable code. The print application 222 then automatically configures the document for printing, based on the printer details and the execution details retrieved from the machine-readable code. Finally, the print application 222 allows the remote user to submit the document for printing such that the document is directly printed at the preferred printer of the requesting user without requiring the remote user to share the document with the requesting user. The print application 222 submits the document for printing at the preferred printer near the requesting user, i.e., the printer 210. The preferred printer, i.e., the printer 210, finally prints the document for the requesting user according to the execution details, wherein the preferred printer is deployed at the requesting user's end.

### Exemplary Snapshots

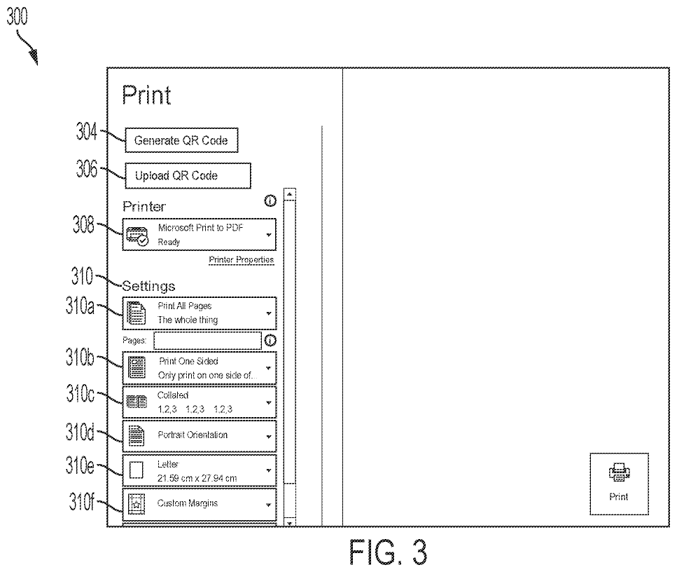

FIG. 3 illustrates an exemplary snapshot 300 of a user interface 302 of a print application according to an embodiment of the present disclosure. As illustrated, the user interface 302 displays various conventional options such as printer option labeled as 308, which allows a requesting user to select a preferred printer for printing. The user interface 302 also includes a settings option labeled as 310, which further includes multiple options to allow a user, such as a requesting user to configure various parameters related to the print such as pages to be printed (labeled 310a), single-sided or both sided print (labeled as 310b), collation (labeled as 310c), orientation (labeled as 310d), page size (labeled as 310e), and margins (labeled as 310f). In the context of the disclosure, the user interface 302 includes two new options including generate QR code option labeled as 304 and upload QR code option labeled as 306.

The generate QR code option 304 allows a requesting user to generate a QR code for printing a document. In this case, the requesting user uses the option to generate a QR code for printing the document belonging to the remote user or the requesting user uses the option to generate the QR code for receiving the printed document from the remote user. Further, the upload QR code option 306 allows a user to upload the QR code for printing the document directly at a printer near the requesting user, i.e., the preferred printer. In this case, the remote user uses the option to upload the QR code.

### Exemplary Flowchart

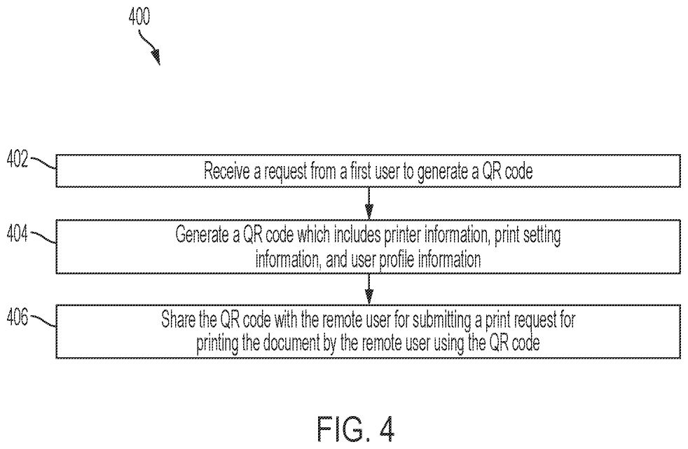

FIG. 4 is a method flowchart 400 for generating a machine-readable code such as a QR code for printing a document for a requesting user. For easy understanding, the disclosure is explained with respect to a QR code, however, the disclosure can be implemented using any known or later-developed machine-readable codes. The method 400 may be implemented at a print application, such as print application 104 installed on the first computing device 102 of FIG. 1, or the print application 204 installed on the first computing device 202 of FIG. 2. However, the method 400 may be implemented at any equivalent device on which a print application can be installed.

The method 400 begins when a requesting user wants a document from another user, i.e., a remote user. The remote user is located at a location remote from the requesting user, therefore the remote user cannot directly hand over the document or share the printed document with the requesting user. The document is confidential, therefore, the remote user does not want to share the digital version of the document directly with the requesting user to avoid modification or edits to the document. Therefore, the requesting user accesses a print application such as a print driver installed on a computing device of the requesting user. Upon accessing, multiple options are displayed to the requesting user for configuring a print job. Exemplary options include a printer selection option which allows the requesting user to select a preferred printer from a list of printers, options to provide execution details such as single-sided or both-sided print; black and white or colored print; number of copies, orientation, etc. In the context of the current disclosure, a new option, say “generate machine-readable code” is included in the print application. The new option allows the requesting user to generate a machine-readable code such as a QR code to get a document, i.e., the printed document, from another user, i.e., the remote user, directly at the preferred printer of the requesting user or printed at the requesting user's end. After configuring the print job, the requesting user selects the new option.

Once selected, at 402, a request is received from the requesting user for generating the machine-readable code for printing the document for the requesting user.

Upon receiving the request, at 404, details related to printing the document are obtained. Here, the details include requesting user details, printer details of a preferred printer of the requesting user, and execution details. For example, the requesting user details such as username, user ID, employee ID, email address, etc., are directly obtained from the computing device or login details of the requesting user. The printer details can be taken from the requesting user, for example, the requesting user can input the name of the preferred printer or select the preferred printer. Then, printer details such as IP address, MAC address, Hostname, Domain name, or any other suitable identifier associated with the printer are automatically retrieved. The execution details describe the details according to the which the document is printed, for example, the number of copies, number of pages to be printed, type of printing, print orientation, etc.

Upon obtaining the details required for printing, at 406, a machine-readable code is generated. The generated machine-readable code includes details related to printing the document, i.e., printer details, requesting user details, and execution details. After this, the generated machine-readable code is displayed to the requesting user.

Once displayed, at 408, the requesting user is allowed to share the machine-readable code with a remote user. The machine-readable code is shared with the remote user. The machine-readable code is shared with the remote user via an e-mail, text message, chat applications, or the like. The machine-readable code is shared with the remote user such that the remote user can submit the document for printing for the requesting user at the preferred printer of the requesting user without sharing the document with the requesting user.

Although the method 400 is explained with respect to a scenario where the print application is installed on the computing device of the requesting user for generating a machine-readable code. However, the print application can be installed on a printer for generating a machine-readable code.

### Exemplary Flowchart

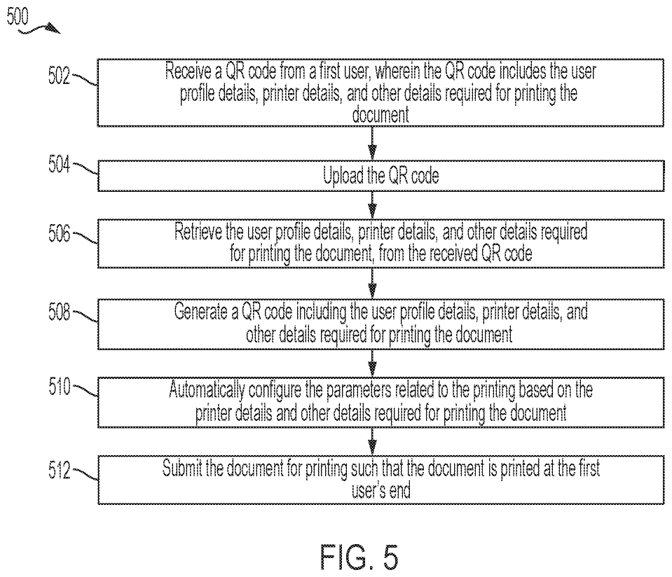

FIG. 5 is a method flowchart for printing a document using a machine-readable code such as a QR code for a requesting user. The method 500 may be implemented at a print application 116 installed on a second computing device 110 of the remote user of FIG. 1, or the print application 222 of the second computing device 220 of the remote user as shown in FIG. 2. However, the method 500 may be implemented at any equivalent device on which a print application or print driver can be installed. The method flowchart 500 is implemented at the remote user's end, specifically, at the computing device of the remote user.

The method 500 begins when a requesting user shares a machine-readable code such as a QR code with the remote user for printing a document for the requesting user. In other words, the requesting user shares the machine-readable code with the remote user for receiving a printed document from the remote user. The machine-readable code can be shared with the remote user using known ways or later-developed ways. Once shared, the machine-readable code is received by the remote user. The received machine-readable code includes details related to printing the document. The details include the printer details of a preferred printer of the requesting user, requesting user details, and execution details. The printer details include information related to one or more identifiers associated with the preferred printer of the requesting user. Exemplary identifiers include IP address, MAC address, Hostname, Domain name, or any other suitable identifier associated with the preferred printer of the requesting user or the printer selected by the requesting user. Execution details include information related to various print setting parameters, such as paper size, print type, pages to be printed, and the like, selected by the requesting user. The requesting user details include user name, user ID, etc., associated with the requesting user. Upon receiving the machine-readable code, the remote user accesses the requested/desired document requested by the requesting user on his computing device. The remote user initiates a print action by selecting a print option included in the print application. A number of options are displayed/included in the print application that allows the remote user to configure a print job/document for printing for the requesting user. Such options include printer selection option, options for proving execution details, etc. In the context of the current disclosure, a new option, say “upload machine-readable code” is displayed to the remote user. The new option allows the remote user to upload the machine-readable code obtained from the remote user and submit the document for printing for the requesting user.

The remote user selects the new option and once selected, at 502 a request to upload the machine-readable code is received from the remote user. As discussed earlier, the machine-readable code includes printer details of a preferred printer of the requesting user, requesting user details, and execution details. After selecting the new option, the remote user uploads the received machine-readable code.

At 504, the machine-readable code is processed and the details embedded in the machine-readable code including printer details, requesting user details, and execution details are retrieved for printing the document.

At 506, the print job for printing the document is automatically configured according to the details retrieved from the machine-readable code. Here, the remote user does not need to manually input any details but details are automatically retrieved and taken from the machine-readable code. For example, printer details such as IP address, MAC address, hostname, domain name, etc., are retrieved from the machine-readable code and used to select the printer, i.e., the preferred printer. Similarly, the parameters related to execution details, i.e., print type, orientation, margins, page size, and the like, are retrieved from the machine-readable code and automatically populated in the print application for printing the document.

Once the print job for printing the document is configured based on the details retrieved from the machine-readable code, at 508, the remote user is allowed to submit the document for printing. Here, the document for printing is submitted such that the document gets directly submitted and printed using the printer at the requesting user's end, i.e., on the preferred printer of the requesting user without requiring the remote user to share the document with the requesting user. The requesting user finally collects the printed document and may use the document for a desired purpose. This way, the requesting does not get the actual document belonging to the remote user.

This way, the method 500 allows the remote to submit a document for printing for the requesting user without requiring the remote user to share the actual document with the requesting user. This prevents further circulation of the actual document of the remote user and/or modification to the document.

FIG. 6 is a complete method flowchart for printing a document using a machine-readable code. The method flow chart can be implemented at a print application running on a device such as a computing device. Some blocks of the flow chart can be implemented at a print application running on a computing device of a requesting user while some blocks of the method can be implemented at a print application running on a computing device of a remote user.

At 602, a request from a requesting user is received for generating a machine-readable code for printing a document for the requesting user. Upon receiving the request, details for printing the document such as requesting user details, printer details of a preferred printer of the requesting user, and execution details are obtained. Then, the machine-readable code is generated for printing the document at 604. The details such as printer details of the preferred printer of the requesting user, requesting user details, and execution details are embedded in the machine-readable code. Once generated, at 606, the requesting user is allowed to share the machine-readable code. Here, the generated machine-readable code is shared with the remote user for printing the document for the requesting user. Finally, the remote user receives the machine-readable code.

At 608, a request to upload the machine-readable code is received from the remote user, the machine-readable code includes at least: the requesting user details, the printer details of the preferred printer of the requesting user, and the execution details. At 610, the requesting user details, the printer details, and the execution details are retrieved from the machine-readable code. Based on the printer details and the execution details retrieved from the machine-readable code, the document or the print job is automatically configured for printing at 612. Once configured, at 614, the remote user is allowed to submit the document for printing such that the document is directly printed at the preferred printer of the requesting user without requiring the remote user to share the document with the requesting user. Once submitted, the document is listed in a job queue associated with the requesting user on the preferred printer. For this, the requesting user details retrieved from the machine-readable code is used to identify the job queue associated with the requesting user, and once identified, the document is listed in the identified job queue. Once listed, the document is printed at the preferred printer of the requesting user.

The present disclosure discloses methods and systems for printing a document using a machine-readable code such as a QR code. The methods and systems include two aspects: in the first aspect, a machine-readable code such as QR code is generated at a requesting user's end and further shared with a remote user and in the second aspect, the generated machine-readable code, i.e., the QR code, is used/uploaded to submit the document for printing at a printer near the requesting user, without sharing the document with the requesting user. The methods and systems take care of situations where a user such as a requesting user needs a document from another user such as a remote user without requiring the remote user to share his actual document.

The present disclosure discloses methods and systems that allow a user, say a remote user to print a document for another user, say a requesting user via a printer selected by the requesting user. Therefore, the methods and systems offer a convenient and simple solution for sharing the document, as the remote user is not required to physically hand over the document to the requesting user. And, thus the manual work is also reduced. Further, the remote user is not required to share a digital version of the document. Therefore, the chances of mishandling of the digital version of the document are also managed. Furthermore, the methods and systems can be easily implemented on existing print applications, e.g., print driver, just by making slight changes.

Although, the disclosure is discussed with respect to a scenario where a requesting user uses his/her computing device to generate a machine-readable code for a remote user. However, the disclosure can be implemented to allow a user to generate the machine-readable code, such as a QR code using a printer or any device with printing capabilities. In such a scenario, the requesting user uses a print application, such as a print driver installed on the printer to generate the machine-readable code, i.e., a QR code. In detail, once the requesting user accesses the print application, multiple options are displayed to the requesting user to configure a print job which includes various options for configuring execution details such as print type (black and white/colored print), orientation, pages to be printed, and so on. Once displayed, the requesting user selects the desired options and configures the print job. Further, a new option, say generate QR code is also displayed to the requesting user which allows the requesting user to generate the QR code. Once displayed, the requesting user selects the new option. Thereafter, the print application obtains IP address of the printer and execution details which includes print setting-related information. Further, the print application obtains requesting user details. Once obtained, the print application generates the QR code using the obtained information. Once generated, the QR code is displayed to the requesting user, thereafter, the requesting user is allowed to share the QR code with the remote user. The requesting user may e-mail the QR code using the printer or may share the QR code via cloud storage. Once shared, the remote user selects the document to be printed and initiates the print job. Thereafter, the requesting user uploads the QR code and once uploaded, information embedded in the QR code is retrieved which includes printer details (printer IP address), execution details, requesting user details, etc. Thereafter, the print job is automatically configured using the information retrieved from the QR code, such that the printer/printer is selected using the printer details, which in the current scenario is the printer from which the QR code is received. Further, other parameters related to the print job are also configured based on the retrieved execution details. Once configured, the remote user is allowed to submit the print job. Once submitted, the print job along with the retrieved requesting user details (i.e., user details of the requesting user) is received at the printer. And, using the requesting user details, the print job is saved in a queue associated with the requesting user. Thereafter, the requesting user is allowed to print the document.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above-described system and/or the apparatus and/or any electronic device (not shown).

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms is deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as receiving, generating, printing, sharing, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in a transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for generating a machine-readable code for printing a document for a requesting user, the method comprising:
wherein the method is implemented on a computing device used by the requesting user,
receiving a request from the requesting user for generating the machine-readable code for printing the document for the requesting user;
obtaining details related to printing the document, wherein the details comprise printer details of a preferred printer of the requesting user, requesting user details, and execution details;
generating the machine-readable code comprising the details related to printing the document; and
allowing the requesting user to share the machine-readable code with a remote user such that the remote user submits the document for printing for the requesting user at the preferred printer without sharing the document with the requesting user.

2. The method of claim 1, further comprising, automatically retrieving the requesting user details from the printer.

3. The method of claim 1, further comprising, storing the printer details of the preferred printer of the requesting user, requesting user details, and execution details for later retrieval and/or use.

4. The method of claim 1, wherein the machine-readable code is generated corresponding to the document to be shared with the requesting user by the remote user.

5. The method of claim 1, further comprising, receiving the generated machine-readable code comprising the printer details, requesting user details, and execution details, by the remote user from the requesting user.

6. The method of claim 5, further comprising, receiving an upload request for uploading the received machine-readable code by the remote user to a print application.

7. The method of claim 6, further comprising, automatically retrieving the printer details, requesting user details, and execution details, from the received machine-readable code.

8. The method of claim 7, further comprising, automatically configuring a print job for printing the document based on the retrieved printer details and execution details.

9. The method of claim 8, further comprising, allowing the remote user to submit the print job for printing the document such that the document is printed for the requesting user at the preferred printer of the requesting user.

10. The method of claim 1, further comprising, printing the document at the preferred printer of the requesting user.

11. A method for submitting a print job for a requesting user using a machine-readable code, the method comprising:
wherein the method is implemented at a print application running on a computing device of a remote user,
receiving a request to upload a machine-readable code, wherein the machine-readable code comprises at least one of: printer details of a preferred printer of the requesting user, requesting user details, and execution details;
retrieving the printer details, requesting user details, and execution details, from the machine-readable code;
automatically configuring the print job based on the printer details and the execution details retrieved from the machine-readable code; and
allowing the remote user to submit the print job including a document such that the document is directly printed at the preferred printer of the requesting user without requiring the remote user to share the document with the requesting user.

12. The method of claim 11, further comprising, receiving a selection of the document to be submitted for printing by the remote user.

13. The method of claim 11, further comprising, printing the document at the preferred printer of the requesting user.

14. A computing device for generating a machine-readable code for printing a document for a requesting user, the computing device is for:
receiving a request from the requesting user for generating the machine-readable code for printing the document for the requesting user;
obtaining details related to printing the document, wherein the details comprise printer details of a preferred printer of the requesting user, requesting user details, and execution details;
generating the machine-readable code comprising the details related to printing the document; and
allowing the requesting user to share the machine-readable code with a remote user such that the remote user submits the document for printing for the requesting user at the preferred printer without sharing the document with the requesting user.

15. The computing device of claim 14 is, further configured for automatically retrieving the requesting user details from the computing device.

16. The computing device of claim 14, is, further configured for storing the printer details, requesting user details, and execution details for later retrieval and/or use.

17. The computing device of claim 14, wherein the printer details comprising details associated with the requesting user's preferred printer.

18. A computing device for submitting a print job for a requesting user, the computing device is for:
receiving a request to upload a machine-readable code, wherein the machine-readable code comprises at least one of: printer details of a preferred printer of the requesting user, requesting user details, and execution details;
retrieving the printer details, requesting user details, and execution details, from the machine-readable code;
automatically configuring the print job based on the printer details and the execution details retrieved from the machine-readable code; and
allowing the remote user to submit the print job including a document such that the document is directly printed at the preferred printer of the requesting user without requiring the remote user to share the document with the requesting user.

19. The computing device of 18, is further configured for receiving a selection of the document to be submitted for printing by the remote user.

20. The computing device of claim 18 is communicatively coupled to a preferred printer of the requesting user, where the preferred printer prints the document for the requesting user.

21. A method for printing a document for a requesting user using a machine-readable code, wherein the document belongs to a remote user, the method comprising:
receiving a request from the requesting user for generating the machine-readable code for printing the document for the requesting user;
generating the machine-readable code comprising details for printing the document, wherein the details comprise at least: printer details of a preferred printer of the requesting user, requesting user details, and execution details;
allowing the requesting user to share the machine-readable code with the remote user for printing the document;
receiving a request to upload the machine-readable code from the remote user, wherein the machine-readable code comprises at least: the printer details of the preferred printer of the requesting user, requesting user details, and execution details;
retrieving the printer details, requesting user details, and execution details, from the machine-readable code;
automatically configuring the document for printing, based on the printer details and the execution details retrieved from the machine-readable code; and
allowing the remote user to submit the document for printing such that the document is directly printed at the preferred printer of the requesting user without requiring the remote user to share the document with the requesting user.

22. A system for printing a document for a requesting user using a machine-readable code, wherein the document belongs to a remote user, the system comprises:
a requesting user's device for:
receiving a request from the requesting user for generating the machine-readable code for printing the document for the requesting user;
generating the machine-readable code comprising details for printing the document, wherein the details comprise at least: printer details of the preferred printer of the requesting user, requesting user details, and execution details;
allowing the requesting user to share the machine-readable code with the remote user for printing the document
a remote computing device for:
receiving a request to upload the machine-readable code from the remote user, wherein the machine-readable code comprises at least: the printer details of a preferred printer of the requesting user, requesting user details, and execution details;
retrieving the printer details, requesting user details, and execution details, from the machine-readable code;
automatically configuring the document for printing, based on the printer details and the execution details retrieved from the machine-readable code; and
allowing the remote user to submit the document for printing such that the document is directly printed at the preferred printer of the requesting user without requiring the remote user to share the document with the requesting user.

23. The system of claim 22, further comprises a printer for printing the for the printing the document for the requesting user according to the execution details, wherein the printer is deployed at the requesting user end.
